(19) United States
(12) Patent Application Publication
(10) Pub. No.: US 2024/0140268 A1
(43) Pub. Date: May 2, 2024

(54) CHARGING AMOUNT REGULATING DEVICE, AND VEHICLE

(71) Applicant: Isuzu Motors Limited, Yokohama-shi, Kanagawa (JP)

(72) Inventor: Sho OZAKI, Fujisawa-shi, Kanagawa (JP)

(73) Assignee: Isuzu Motors Limited, Yokohama-shi, Kanagawa (JP)

(21) Appl. No.: 18/280,247

(22) PCT Filed: Mar. 1, 2022
(86) PCT No.: PCT/JP2022/008583

§ 371 Date: Sep. 4, 2023

(30) Foreign Application Priority Data
Mar. 5, 2021 (JP) 2021-035174

(51) Int. Cl. B60L 58/22; H01M 10/44; H01M 10/48; H02J 7/00; H02J 7/34

(52) U.S. Cl. CPC B60L 58/22; H01M 10/441; H01M 10/482; H02J 7/00712; H02J 7/342; H01M 2220/20

(57) ABSTRACT

Provided are a charging amount regulating device and a vehicle with which it is possible to perform capacity regulation corresponding to a state of a battery assembly, without giving rise to an increase in cost. This charging amount regulating device performs capacity regulation between first and second battery cells constituting a battery assembly. The charging amount regulating device is provided with: a first discharging unit in which a first discharging resistor is connected in parallel with the first battery cell to discharge the first battery cell; a second discharging unit in which a second discharging resistor is connected in parallel with the second battery cell to discharge the second battery cell; and a third discharging unit in which the first and second discharging resistors are connected in series with the first battery cell to discharge the first battery cell.

### TECHNICAL FIELD

The present disclosure relates to a charging amount regulating device and a vehicle.

### BACKGROUND ART

At present, a battery pack unit including a plurality of battery packs connected in series is commercialized as a power source for a motor mounted in a vehicle such as an electric vehicle or a hybrid vehicle. Each of the battery packs (batteries) has a structure in which rechargeable secondary battery cells (battery cells) such as lead-acid battery cells, nickel-hydrogen battery cells, and lithium-ion battery cells are connected in series.

In the meantime, in the battery pack, an imbalance in the battery cell voltage (charge amount) is caused between the battery cells due to individual differences (variations) in characteristics of capacities, leakages, and/or the like of the battery cells.

When a battery pack in which a plurality of battery cells having such an imbalance are connected is charged, a battery cell with a high charge amount is overcharged first, and charging is stopped even when there is a cell for which the charge amount has not reached a full charge (charge ending voltage).

On the other hand, at the time of discharging, a battery cell having a low charge amount is overdischarged first, and the battery pack cannot be used unless it is recharged, even when another battery cell is still usable.

When the charge amounts are unbalanced as described above, an effective battery voltage use range is narrowed, and not only the actual capacity of the battery is reduced, but also abnormal conditions such as overcharge and overdischarge frequently occur. Further, the performance of the entire battery pack decreases, and the progress of the deterioration of the battery pack is accelerated.

Therefore, in order to eliminate the imbalance in the charge amounts between the battery cells and prevent an actual decrease in the battery capacity of the battery pack, a cell balance adjustment technique (charge amount adjustment technique) has been put into practical use. In the cell balance adjustment technique, a battery cell having a high charge amount is discharged with reference to a battery cell having a low charge amount at the time of charging. Accordingly, the charge amounts in the battery pack are made even (adjusted).

In connection with the cell balance adjustment technique, Patent Literature (hereinafter, referred to as “PTL”) 1 describes a technique of setting an adjustment capability improvement degree for capacity adjustment at a predetermined capacity adjustment current value according to a state of a battery (for example, a cell voltage distribution condition of a battery pack) in order to shorten a capacity adjustment time (a discharge time of a battery cell), and performing capacity adjustment at the capacity adjustment current value changed based on the adjustment capability improvement degree. In this technique, for example, a method of connecting a resistance circuit having a variable resistance value to each battery cell in parallel is described as a method of performing the capacity adjustment (charge amount adjustment). As the resistance circuit, a configuration is described in which a plurality of capacitance adjustment resistors are disposed, and at least one of them is selected by a switch and connected in parallel to a battery cell.

### CITATION LIST

### Patent Literature

PTL 1
Japanese Patent Application Laid-Open No. 2008-21589

### SUMMARY OF INVENTION

### Technical Problem

However, the technique described in above PTL 1 has a problem that it is necessary to dispose a plurality of capacitance adjustment resistors in the resistance circuit connected in parallel to each battery cell, and thus, the cost of the resistance circuit is increased.

An object of the present disclosure is to provide a charge amount adjustment apparatus and a vehicle capable of adjusting a charge amount according to a state of a battery without incurring an increase in cost.

### Solution to Problem

According to an aspect of the present disclosure, a charging amount regulating device is
a charging amount regulating device for adjusting a charge amount between first and second battery cells constituting a battery, the charging amount regulating device including:
a first discharge section configured to discharge the first battery cell by connecting a first discharge resistor in parallel to the first battery cell;
a second discharge section configured to discharge the second battery cell by connecting a second discharge resistor in parallel to the second battery cell; and
a third discharge section configured to discharge the first battery cell by connecting the first and the second discharge resistors in series to the first battery cell.

A vehicle according to an aspect of the present disclosure includes: the above-described charging amount regulating device.

### Advantageous Effects of Invention

According to the present disclosure, it is possible to adjust the charge amount according to the state of the battery without incurring an increase in cost.

### BRIEF DESCRIPTION OF DRAWINGS

FIG. 1 is a diagram illustrating a configuration example of a battery pack including a charging amount regulating device according to the present embodiment;

FIG. 2 is a diagram illustrating an example in which a first discharge resistor is connected in parallel to a first battery cell to discharge the first battery cell;

FIG. 3 is a diagram illustrating an example in which first, second, and third discharge resistors are connected in series to the first battery cell to discharge the first battery cell;

FIG. 4 is a diagram illustrating an example in which the second discharge resistor is connected in parallel to a second battery cell to discharge the second battery cell;

FIG. 5 is a diagram illustrating an example in which first, second, and third discharge resistors are connected in series to the second battery cell to discharge the second battery cell;

FIG. 6 is a diagram illustrating an example in which the third discharge resistor is connected in parallel to a third battery cell to discharge the third battery cell; and

FIG. 7 is a diagram illustrating an example in which the first, second, and third discharge resistors are connected in series to the third battery cell to discharge the third battery cell.

### DESCRIPTION OF EMBODIMENTS

Hereinafter, one embodiment of the present disclosure will be described in detail with reference to the drawings. To begin with, a configuration of a charging amount regulating device according to an embodiment of the present disclosure will be described.

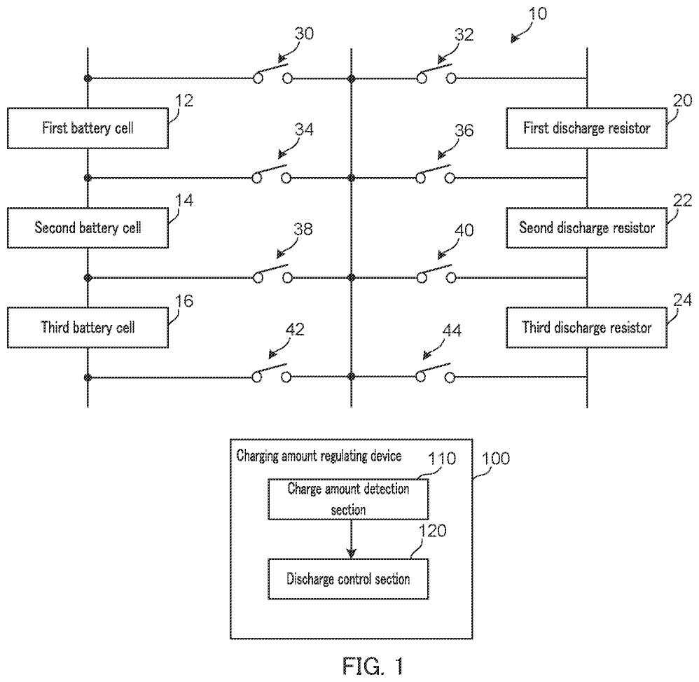

FIG. 1 is a block diagram illustrating an example of a configuration of a battery pack including the charging amount regulating device according to the present embodiment.

Charging amount regulating device 100 illustrated in FIG. 1 is, for example, a cell controller, and adjusts the charge amounts between first, second, and third battery cells 12, 14, and 16 constituting the battery pack (battery) included in a battery pack unit. First, second, and third battery cells 12, 14, and 16 are rechargeable secondary battery cells such as lead-acid battery cells, nickel-metal hydride battery cells, and lithium-ion battery cells, and are connected in series to one another. The battery pack unit is used as a power source for a motor mounted in an electric vehicle, a hybrid vehicle, or the like. Charging amount regulating device 100 is included in the battery pack unit together with first, second, and third battery cells 12, 14, and 16 constituting the battery pack. In the present embodiment, charging amount regulating device 100 will be described as being mounted on an electric vehicle, a hybrid vehicle, or the like (hereinafter, referred to as a vehicle).

First, second, and third battery cells 12, 14, and 16 are connected to resistance circuit 10 (discharge circuit) for discharging the voltage stored in first, second, and third battery cells 12, 14, and 16 to reduce the charge amount. Resistance circuit 10 is provided with switches 30, 32, 34, 36, 38, 40, 42, and 44, and first, second, and third discharge resistors 20, 22, and 24. In the present embodiment, the resistance values of first, second, and third discharge resistors 20, 22, and 24 are set to lower values in order to shorten the discharge time in the case of parallel connection of first, second, and third discharge resistors 20, 22, and 24 to first, second, and third battery cells 12, 14, and 16.

Switches 30, 32, 34, 36, 38, 40, 42, and 44 are, for example, contactors (electromagnetic contactors), electromagnetic relays, and/or the like, and are turned on (closed) and off (opened) by a drive signal from charging amount regulating device 100. When charging amount regulating device 100 is activated, switches 30, 32, 34, 36, 38, 40, 42, and 44 are all turned off.

As illustrated in FIG. 1, charging amount regulating device 100 includes charge amount detection section 110 and discharge control section 120. Note that discharge control section 120 functions as the “first discharge section,” the “second discharge section,” and the “third discharge section” of the present disclosure.

Charge amount detection section 110 detects the charge amounts (State Of Charge: SOC) of first, second, and third battery cells 12, 14, and 16, and outputs the detected charge amounts to discharge control section 120. The charge amounts of first, second, and third battery cells 12, 14, and 16 can be calculated, for example, from detection values of voltage sensors and current sensors disposed in first, second, and third battery cells 12, 14, and 16. Note that the method of detecting the charge amounts is not limited to the method of calculating the charge amounts from the detection values of the voltage sensors and the current sensors.

Discharge control section 120 controls the discharge of first, second, and third battery cells 12, 14, and 16 by controlling the operation of switches 30, 32, 34, 36, 38, 40, 42, and 44 based on the charge amounts of first, second, and third battery cells 12, 14, and 16 output from charge amount detection section 110. Specifically, in a case where an imbalance in the charge amounts occurs between first, second, and third battery cells 12, 14, and 16, discharge control section 120 discharges a battery cell having a high charge amount with reference to a battery cell having a low charge amount in order to eliminate the imbalance and prevent a decrease in the actual battery capacity of the battery pack.

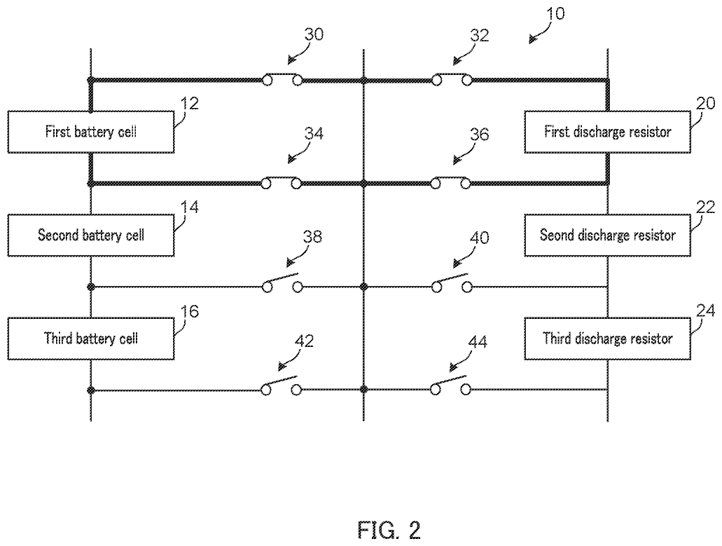

For example, when discharging first battery cell 12 having a high charge amount with reference to second and third battery cells 14 and 16 having low charge amounts, discharge control section 120 connects first discharge resistor 20 to first battery cell 12 in parallel when a charge capacity difference between first battery cell 12 and second and third battery cells 14 and 16 is equal to or greater than a predetermined value (for example, when the vehicle is left unactuated, when charging amount regulating device 100 is not turned on, and when the charge amount adjustment is not performed for a long time). Specifically, as illustrated in FIG. 2, discharge control section 120 turns on switches 30, 32, 34, and 36 and turns off switches 38, 40, 42, and 44, thereby connecting first discharge resistor 20 to first battery cell 12 in parallel (see a closed circuit formed by connecting thick lines). As a result, a large discharge current flows through first discharge resistor 20, and first battery cell 12 is discharged. As a result, even in a case where the imbalance in the charge amounts is large between first, second, and third battery cells 12, 14, and 16, the charge amounts in the battery pack can be made even in a short time by discharging first battery cell 12 having a high charge amount at a large discharge amount.

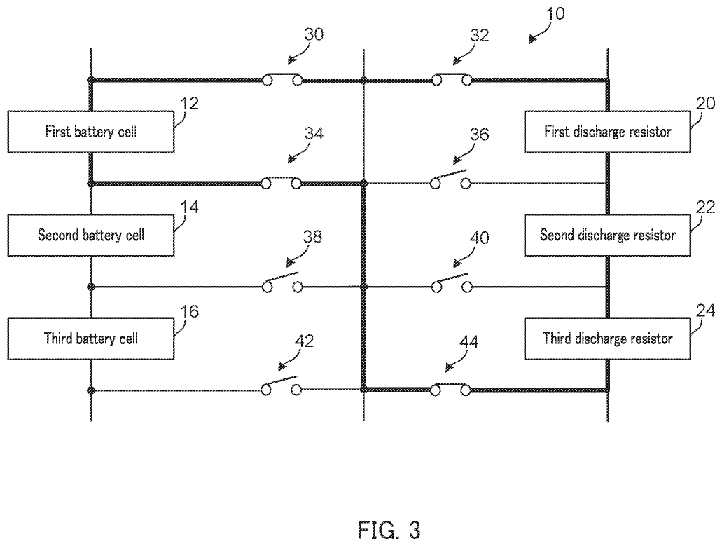

On the other hand, when the charge capacity difference between first battery cell 12 and second and third battery cells 14 and 16 is less than the predetermined value, discharge control section 120 connects first, second and third discharge resistors 20, 22, and 24 to first battery cell 12 in series. Specifically, as illustrated in FIG. 3, discharge control section 120 turns on switches 30, 32, 34, and 44, and turns off switches 36, 40, 42, and 44, thereby connecting first, second, and third discharge resistors 20, 22, and 24 in series to first battery cell 12 (see a closed circuit formed by connecting thick lines). As a result, a small discharge current flows through the combined resistance of first, second, and third discharge resistors 20, 22, and 24, and first battery cell 12 is discharged. Consequently, in a case where the imbalance in the charge amounts is not large between first, second, and third battery cells 12, 14, and 16, the charge amounts in the battery pack can be made even by discharging first battery cell 12 having a high charge amount at a small discharge amount. In the present embodiment, the combined resistance value of first, second, and third discharge resistors 20, 22, and 24 is smaller than the resistance values of first, second, or third discharge resistors 20, 22, and 24.

Further, since first battery cell 12 can be discharged while a small discharge current flows, overdischarge of first battery cell 12 can be prevented when the charge amount of first battery cell 12 is adjusted to the charge amounts of second and third battery cells 14 and 16. From this viewpoint, in a case where the charge capacity difference between first battery cell 12 and second and third battery cells 14 and 16 is equal to or greater than a predetermined value, first discharge resistor 20 may first be connected in parallel to first battery cell 12 and first battery cell 12 may be discharged at a large discharge amount, and thereafter, first, second, and third discharge resistors 20, 22, and 24 may be connected in series to first battery cell 12 and first battery cell 12 may be discharged at a small discharge amount.

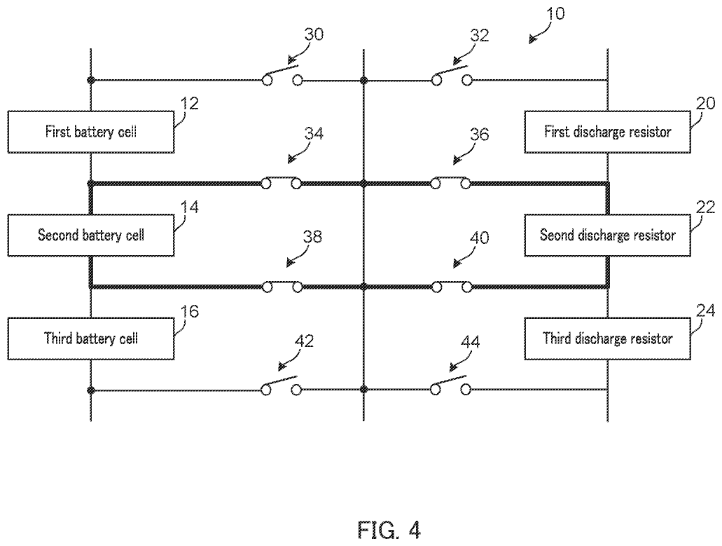

Further, when discharging second battery cell 14 having a high charge amount with reference to first and third battery cells 12 and 16 having a low charge amount, discharge control section 120 connects second discharge resistor 22 to second battery cell 14 in parallel (see a closed circuit formed by connecting thick lines) when the charge capacity difference between second battery cell 14 and first and third battery cells 12 and 16 is equal to or greater than a predetermined value (for example, when the vehicle is left unactuated, when charging amount regulating device 100 is not turned on, and when the charge amount adjustment is not performed for a long time). Specifically, as illustrated in FIG. 4, discharge control section 120 turns on switches 34, 36, 38, and 40 and turns off switches 30, 32, 42, and 44, thereby connecting second discharge resistor 22 to second battery cell 14 in parallel. As a result, a large discharge current flows through second discharge resistor 22, and second battery cell 14 is discharged. As a result, even in a case where the imbalance in the charge amounts is large between first, second, and third battery cells 12, 14, and 16, the charge amounts in the battery pack can be made even in a short time by discharging second battery cell 14 having a high charge amount at a large discharge amount.

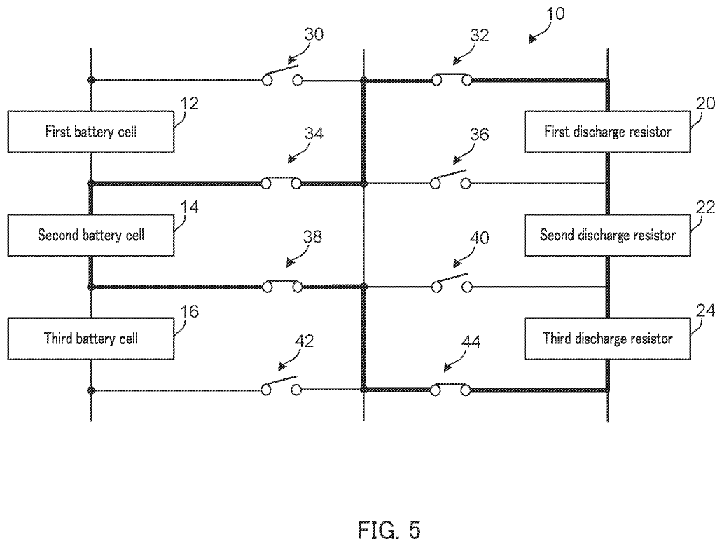

On the other hand, when the charge capacity difference between second battery cell 14 and first and third battery cells 12 and 16 is less than the predetermined value, discharge control section 120 connects first, second, and third discharge resistors 20, 22, and 24 to second battery cell 14 in series. Specifically, as illustrated in FIG. 5, discharge control section 120 turns on switches 32, 34, 38, and 44 and turns off switches 30, 36, 40, and 42 to connect first, second, and third discharge resistors 20, 22, and 24 in series to second battery cell 14 (see a closed circuit formed by connecting thick lines). As a result, a small discharge current flows through the combined resistance of first, second, and third discharge resistors 20, 22, and 24, and second battery cell 14 is discharged. Consequently, in a case where the imbalance in the charge amounts is not large between first, second, and third battery cells 12, 14, and 16, the charge amounts in the battery pack can be made even by discharging second battery cell 14 having a high charge amount at a small discharge amount.

As described above, second battery cell 14 can be discharged while a small discharge current flows. Thus, overdischarge of second battery cell 14 can be prevented when the charge amount of second battery cell 14 is adjusted to the charge amounts of first and third battery cells 12 and 16. From this viewpoint, in a case where the charge capacity difference between second battery cell 14 and first and third battery cells 12 and 16 is equal to or greater than a predetermined value, second discharge resistor 22 may first be connected to second battery cell 14 in parallel and second battery cell 14 may be discharged at a large discharge amount, and thereafter, first, second, and third discharge resistors 20, 22, and 24 may be connected in series to second battery cell 14 and second battery cell 14 may be discharged at a small discharge amount.

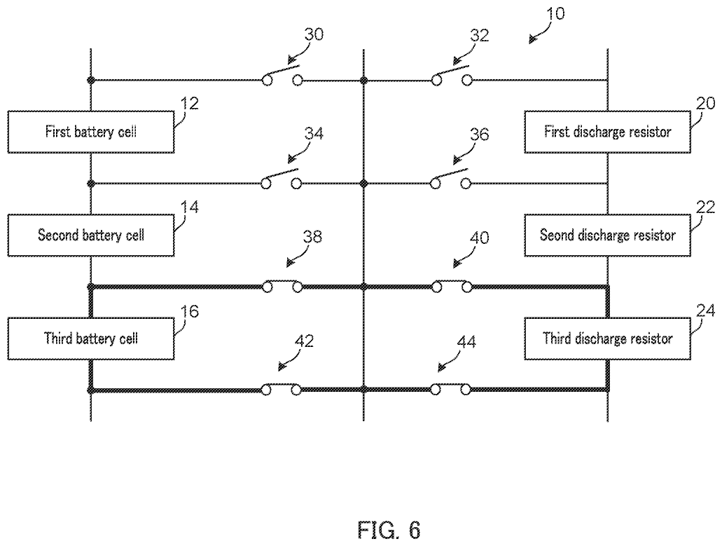

Further, when discharging third battery cell 16 having a high charge amount with reference to first and second battery cells 12 and 14 having a low charge amount, discharge control section 120 connects third discharge resistor 24 to third battery cell 16 in parallel (see a closed circuit formed by connecting thick lines) when the charge capacity difference between third battery cell 16 and first and second battery cells 12 and 14 is equal to or greater than a predetermined value (for example, when the vehicle is left unactuated, when charging amount regulating device 100 is not turned on, and when the charge amount adjustment is not performed for a long time). Specifically, as illustrated in FIG. 6, discharge control section 120 turns on switches 38, 40, 42, and 44 and turns off switches 30, 32, 34, and 36, thereby connecting third discharge resistor 24 to third battery cell 16 in parallel. As a result, a large discharge current flows through third discharge resistor 24, and third battery cell 16 is discharged. As a result, even in a case where the imbalance in the charge amounts is large between first, second, and third battery cells 12, 14, and 16, the charge amounts in the battery pack can be made even in a short time by discharging third battery cell 16 having a high charge amount at a large discharge amount.

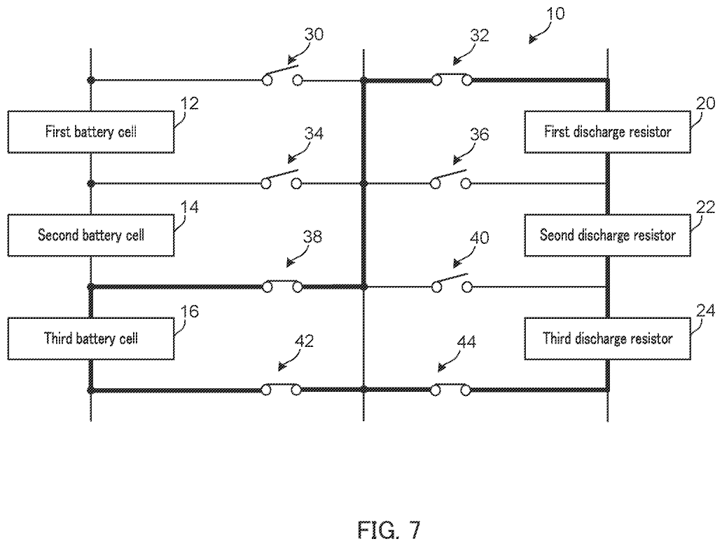

On the other hand, when the charge capacity difference between third battery cell 16 and first and second battery cells 12 and 14 is less than the predetermined value, discharge control section 120 connects first, second, and third discharge resistors 20, 22, and 24 to third battery cell 16 in series. Specifically, as illustrated in FIG. 7, discharge control section 120 turns on switches 32, 38, 42, and 44 and turns off switches 30, 34, 36, and 40 to connect first, second, and third discharge resistors 20, 22, and 24 in series to third battery cell 16 (see a closed circuit formed by connecting thick lines). As a result, a small discharge current flows through the combined resistance of first, second, and third discharge resistors 20, 22, and 24, and third battery cell 16 is discharged. As a result, in a case where the imbalance in the charge amounts is not large between first, second, and third battery cells 12, 14, and 16, the charge amounts in the battery pack can be made even by discharging third battery cell 16 having a high charge amount at a small discharge amount.

Further, since third battery cell 16 can be discharged while a small discharge current flows, overdischarge of third battery cell 16 can be prevented when the charge amount of third battery cell 16 is adjusted to the charge amounts of first and second battery cells 12 and 14. From this viewpoint, in a case where the charge capacity difference between third battery cell 16 and first and second battery cells 12 and 14 is equal to or greater than a predetermined value, third discharge resistor 24 may first be connected in parallel to third battery cell 16 and third battery cell 16 may be discharged at a large discharge amount, and thereafter, first, second, and third discharge resistors 20, 22, and 24 may be connected in series to third battery cell 16 and third battery cell 16 may be discharged at a small discharge amount.

As described in detail above, in the present embodiment, charging amount regulating device 100 is a charge amount adjustment apparatus that adjusts the charge amounts between first and second battery cells 12 and 14 constituting the battery, and includes the first discharge section (discharge control section 120) that connects first discharge resistor 20 in parallel to first battery cell 12 to discharge first battery cell 12, the second discharge section (discharge control section 120) that connects second discharge resistor 22 in parallel to second battery cell 14 to discharge second battery cell 14, and the third discharge section (discharge control section 120) that connects first and second discharge resistors 20 and 22 in series to first battery cell 12 to discharge first battery cell 12.

According to the present embodiment configured as described above, first battery cell 12 can be discharged by connecting first discharge resistor 20 in parallel to first battery cell 12, or first battery cell 12 can be discharged by connecting first and second discharge resistors 20 and 22 in series to first battery cell 12, for example, in accordance with a charge capacity difference between first battery cell 12 and second battery cell 14 without providing a plurality of capacitance adjustment resistors in resistance circuit 10 connected in parallel to first and second battery cells 12 and 14. Therefore, unlike the technique described in PTL 1 in which a plurality of capacitance adjustment resistors need to be provided in a resistance circuit connected in parallel to each battery cell, it is possible to adjust the charge amount according to the state of the battery (battery pack) without incurring an increase in cost.

Note that the above embodiment has been described in relation to an example in which the battery pack is composed of three first, second, and third battery cells 12, 14, and 16, but the present disclosure is not limited thereto. For example, the battery pack may be composed of two battery cells or four or more battery cells.

Further, the above embodiment has been described in relation to an example in which discharge control section 120 connects first, second, and third discharge resistors 20, 22, and 24 in series to first battery cell 12 when the charge capacity difference between first battery cell 12 and second and third battery cells 14 and 16 is less than the predetermined value, but the present disclosure is not limited thereto. For example, when the charge capacity difference between first battery cell 12 and second and third battery cells 14 and 16 is less than the predetermined value, discharge control section 120 may connect two (any two) of first, second, and third discharge resistors 20, 22, and 24 to first battery cell 12 in series. In short, a plurality of optional combined resistances connected in series to first battery cell 12, that is, optional discharge current values from first battery cell 12 may be provided to allow fine adjustment of the discharge current value in accordance with the charge capacity difference between first battery cell 12 and second and third battery cells 14 and 16.

Further, the above embodiment has been described in relation to an example in which discharge control section 120 connects first, second, and third discharge resistors 20, 22, and 24 in series to second battery cell 14 when the charge capacity difference between second battery cell 14 and first and third battery cells 12 and 16 is less than the predetermined value, but the present disclosure is not limited thereto. For example, when the charge capacity difference between second battery cell 14 and first and third battery cells 12 and 16 is less than the predetermined value, discharge control section 120 may connect two (any two) of first, second, and third discharge resistors 20, 22, and 24 to second battery cell 14 in series. In short, a plurality of optional combined resistances connected in series to second battery cell 14, that is, optional discharge current values from second battery cell 14 may be provided to allow fine adjustment of the discharge current value in accordance with the charge capacity difference between second battery cell 14 and first and third battery cells 12 and 16.

Further, the above embodiment has been described in relation to an example in which discharge control section 120 connects first, second, and third discharge resistors 20, 22, and 24 in series to third battery cell 16 when the charge capacity difference between third battery cell 16 and first and second battery cells 12 and 14 is less than the predetermined value, but the present disclosure is not limited thereto. For example, when the charge capacity difference between third battery cell 16 and first and second battery cells 12 and 14 is less than the predetermined value, discharge control section 120 may connect two (any two) of first, second, and third discharge resistors 20, 22, and 24 to third battery cell 16 in series. In short, a plurality of optional combined resistances connected in series to third battery cell 16, that is, optional discharge current values from third battery cell 16 may be provided to allow fine adjustment of the discharge current value in accordance with the charge capacity difference between third battery cell 16 and first and second battery cells 12 and 14.

In addition, the aforementioned embodiments merely describe examples of implementations for practicing the present disclosure, and should not be construed as limiting the technical scope of the present disclosure. That is, the present disclosure can be implemented in various forms without departing from its spirit or key features.

This application is based on Japanese Patent No. 2021-035174 filed on Mar. 5, 2021, the disclosure of which including the specification, drawings and abstract is incorporated herein by reference in its entirety.

### INDUSTRIAL APPLICABILITY

The present disclosure is useful as a charge amount adjustment apparatus and a vehicle capable of performing capacity adjustment according to a state of a battery without causing an increase in cost.

### REFERENCE SIGNS LIST

10 Resistance circuit
12 First battery cell
14 Second battery cell
16 Third battery cell
20 First discharge resistor
22 Second discharge resistor
24 Third discharge resistor
30, 32, 34, 35, 36, 38, 40, 42, 44 Switch
100 Charging amount regulating device
110 Charge amount detection section
120 Discharge control section

1. A charging amount regulating device for adjusting a charge amount between first and second battery cells constituting a battery, the charging amount regulating device comprising:
a first discharge section configured to discharge the first battery cell by connecting a first discharge resistor in parallel to the first battery cell;
a second discharge section configured to discharge the second battery cell by connecting a second discharge resistor in parallel to the second battery cell; and
a third discharge section configured to discharge the first battery cell by connecting the first and the second discharge resistors in series to the first battery cell.

2. The charging amount regulating device according to claim 1, wherein
when a charge capacity difference between the first and the second battery cells is equal to or greater than a predetermined value, the first discharge section connects the first discharge resistor to the first battery cell in parallel, while the third discharge section does not connect the first and second discharge resistors to the first battery cell in series.

3. The charging amount regulating device according to claim 2, wherein
when the charge capacity difference between the first and the second battery cells is less than the predetermined value, the first discharge section does not connect the first discharge resistor to the first battery cell in parallel, while the third discharge section connects the first and the second discharge resistors to the first battery cell in series.

4. A vehicle, comprising:
a charging amount regulating device according to claim 1.
